(19) United States
(12) Patent Application Publication
(10) Pub. No.: US 2008/0070217 A1
(43) Pub. Date: Mar. 20, 2008

(54) Software tool for creating an interactive graphic organizer

(75) Inventors: Mario J. Lopez, Santiago (CL); Hector R. Ponce, Santiago (CL)

Correspondence Address: BANNER & WITCOFF, LTD., 1100 13th STREET, N.W., SUITE 1200, WASHINGTON, DC, 20005-4051, US

(73) Assignee: Universidad de Santiago de Chile, Santiago (CL)

(21) Appl. No.: 11/506,922

(22) Filed: Aug. 21, 2006

(51) Int. Cl. G09B 3/00

(52) U.S. Cl. 434/322

(57) ABSTRACT

The interactive software tool develops and enhances learning strategies and skills of a user in a computer based learning environment (web or local host). The interactive software tool is embedded in a content page. The software tool provides a scheme for a user to enter, into graphical shapes, realistic and organized information; the user can dynamically increase the number of graphical shapes. The software tool instructs the user to select actions to increase the number of shapes and to what to enter in each shape. The interactive software tool includes functions that allow it to work on its own or integrated to larger educational software.

### FIELD OF THE INVENTION

The present invention relates to a computer based learning environment (web or local host). More particularly, the present invention relates to an interactive software tool for developing and enhancing learning strategies and skills of a user in a computer based learning environment (web or local host).

### BACKGROUND OF THE INVENTION

Studies conducted into education show that practitioner's emphasis are centred on WHAT is to be learnt rather than on HOW or WHAT FOR; this reflects that the prevailing educational model is centred on teaching instead of being centred on learning. These practices permeate to distant education assisted with information and communication technologies (ICT's); in particular the teaching centred model has permeated e-learning. Essentially, the teaching model is centred, almost exclusively, in presenting either educational contents or methodological resources for the practice of what has been learnt (case studies, projects, simulations and others). That is; the teaching model trains on contents and intents to evaluate on capability and assigns a passive role to the learner. The more recent capability articulation trains on the content trilogy: conceptual, procedural and attitudinal; however, this approach persists in the indifference towards the development of new cognitive skills for continuous learning.

In contrast, the approach that centres upon the development of new cognitive skills for continuous learning is deep learning. Learning is deep when fresh contents are associated with what the learner already knows. The association is substantial and not by chance, that is, new ideas are related with an existent relevant aspect of the learner's cognitive structure such as an image, a symbol, a concept or a preposition. There is deep learning when meaning is given to the materials being learnt.

An important contribution to deep learning comes from the graphic organizers, which are particularly useful for learners to relate previous with new knowledge. The purpose of the graphic organizers is to keep the learner's attention on the relevant elements as well as to stand out the ideas presented and to evoke already known information.

Learning strategies are defined as consciously selected specific actions to learn contents. The strategies are grouped according to learning processes. For example, awareness on previous knowledge, attention keeping, organization, synthesis and association making are all learning processes that have learning strategies for their improvement. The selection of adequate learning strategies in a learning process, as well as their iterative and systematic use, develops a cognitive automation that improves the learning levels.

The relevance of using visual schemes is that it allows the learner to discover and design patterns, relationships, interdependences and to develop creative thinking. For example a diagram of differences and similarities provides the learner with a visual learning strategy to carry out comparisons that include the schematization of common and differing elements. More generally, the combination of linguistic (words, phrases) and non linguistic elements (symbols, shapes, arrows) to represent relationships are known as graphic organizers. These develop and enhance understanding and skills to use knowledge. Graphic organizers are a powerful and effective tool to develop and enhance learning capabilities and skills and act as mediators between learners and their learning experiences.

In brief, graphic organizers assist in the formative process as a methodological resource to strategically work the deep learning.

U.S. Patent Documents

| Number | Date | Inventors |
|---|---|---|
| 5,287,514 | Feb. 15, 1994 | Gram |
| 5,760,768 | Jun. 2, 1998 | Gram |
| 5,836,304 | Nov. 17, 1998 | Kellinger, et al. |
| 5,947,747 | Sep. 7, 1999 | Walker, et al. |
| 5,957,699 | Sep. 28, 1999 | Peterson, et al. |
| 5,957,699 | Sep. 28, 1999 | Peterson, et al. |
| 6,175,841 | Jan. 16, 2001 | Loiacono |
| 6,296,487 | Oct. 2, 2001 | Lotecka |
| 6,347,943 | Feb. 19, 2002 | Fields, et al. |
| 6,435,880 | Aug. 20, 2002 | Tsumori, et al. |
| 6,466,239 | Oct. 15, 2002 | Ishikawa |

### SUMMARY OF THE INVENTION

The present invention provides an interactive software application for developing and enhancing learning strategies and skills of a user in a computer based learning environment (web or local host). According to an illustrative embodiment, the present invention provides an interactive software tool embedded in a computer based learning environment (web or local host). The software tool provides a number of facilities to practice a determined learning capability or skill. A large number of interactive graphic organizers can be displayed according to the kind of shapes and associations between shapes. FIG. 1 is an illustration of such graphic organizers and FIG. 2 is an example of thirty other possible graphic organizers. There are numerous other graphic organizers.

According to one embodiment of the present invention, a method is provided for use in an electronic device that offers an on-line educational course or other computer based educational course, wherein the software tool provides a dynamic and interactive graphic to fill in with meaningful text. The completed interactive graphic organizer may be forwarded or saved for assessment.

According to another embodiment of the present invention, a method is provided for use in an electronic device that provides an on-line or other computer based educational course, including the steps to use a tool bar that contains embedded actions including instructions to a user to operate the interactive graphic organizer; these give the interactive quality to the graphic organizer; hence Interactive Graphic Organizer (IGO).

A further embodiment of the invention involves a computer-readable medium for use in an electronic device that provides an on-line or other computer based educational course, including instructions for adding shapes and connectors, wherein the user can decide the number of shapes in the interactive graphic organizer.

Another embodiment of the invention provides an electronic device for providing an on-line or other computer based educational course including a processor, a display screen and memory including a Web page having an interactive software tool embedded therein. The processor executes the software tool to generate an interactive graphical user interface on the display screen, the graphical user interface displaying shapes and connectors associated to a specific basic learning capability or skill.

### BRIEF DESCRIPTION OF THE DRAWINGS

The foregoing and other objects, features and advantages of the invention will be apparent from the following description and the accompanying drawings, in which like reference characters refer to the same parts throughout the different views. The drawings illustrate principles of the invention and, although not to scale, show relative dimensions.

FIG. 3 is a block diagram of a distributed environment suitable for implementing an on-line educational course and running the interactive graphic organizer software tool of an illustrative embodiment of the present invention.

FIG. 4 is a block diagram of a client personal computer suitable for use in the illustrative embodiment of the present invention.

FIG. 5a illustrates a Web page including the interactive software tool of the illustrative embodiment. FIG. 5b illustrates the interactive graphic organizer as displayed in a Web page.

FIG. 6 illustrates some of the tool tips available within the interactive graphic organizer.

FIG. 7 illustrates the interactive software tool when a user fills in a correct diagram as showed by the software tool.

FIG. 8 illustrates the interactive software tool after the user has incorrectly filled it in.

FIG. 9 is a flow chart illustrating the steps involved in creating an interactive software tool according to an illustrative embodiment of the present invention.

### DETAILED DESCRIPTION OF A PREFERRED EMBODIMENT

FIGS. 1 through 9 illustrate an example embodiment of a software application suitable for interacting with a user to practice and enhance learning strategies and skills presented in an on-line educational course. Although the present invention will be described with reference to an illustrative embodiment shown in the figures, those skilled in the art will appreciate that the present invention may be implemented in a number of different applications and embodiments and is not specifically limited in its application to the particular embodiment depicted herein.

The software application of the illustrative embodiment provides a mechanism by which a provider of a computer based learning (Web or local host) can assist a student on developing and enhancing his learning strategies and skills. A “computer based learning (Web or local host)” is an organization that provides instruction and practice of skills over a wired and/or wireless communication network, such as the Internet, an intranet, an extranet, a local area network (LAN) and a wide area network (WAN), and other networks enabling communication among computers. Also, the provision can be made within a personal compute, for example, trough a CD ROM or other magnetic, electronic or magnetic device. An on-line network learning centre maintains a server having a domain name associated with the learning centre. Administrators of the learning centre develop, create, edit and/or administer an on-line educational course. An “on-line educational course” is curriculum, such as a training course for a new technology that is delivered to a student over a wired and/or wireless communication network as described above. Course material in the on-line educational course may consist of many units or chapters and may include text, graphics, sound, movies and exercises to be performed by the student. Through the use of the software application, an interactive graphic organizer software tool, the student can practice learning strategies and skills. The interactive software tool provides the student the construction of a personalised graphic organized with as many shapes connectors and its contents.

As used herein the term “shape” refers to a pre design graphical form, of which the student may include up to a predetermined number. The term “connector” as used herein refers to predetermined lines that associate shapes.

The present invention can be implemented in an on-line learning management system. The management system may provide on-line opportunities for students to register in educational courses pertaining to any number of different subject areas, use the information presented in the course and practice learning strategies and skills through the included interactive graphic organizers. To view and use the interactive graphic organizers, it is needed a browser (MS Explorer, Mozilla Firefox, Netscape and others) and the flash plug-in for the browser. The interactive graphic organizers can also be used in a stand alone fashion; that is, each can individually be called to a computer screen through Flash Player, freely distributed software.

Flash, refers to both the Adobe Flash Player and to a multimedia authoring program used to create content for the Adobe Engagement Platform (such as web applications, games and movies). The Flash Player, developed and distributed by Adobe Systems is a client application available in most dominant web browsers. It features support for vector and raster graphics, a scripting language called Action Script and bidirectional streaming of audio and video.

Strictly speaking, Adobe Flash is an integrated development environment (IDE) while Flash Player is a virtual machine used to run, or parse, the Flash files, but in contemporary colloquial terms “Flash” can refer to the authoring environment, the player or the application files. Since its introduction in 1996, Flash technology has become a popular method for adding animation and interactivity to web pages; several software products, systems, and devices are able to create or display Flash. Flash is commonly used to: create animation, advertisements, various web-page components, integrate video into web pages, and more recently, develop Rich Internet Applications like portals.

The Flash files, traditionally called “flash movies”, usually have a .swf (Small Web File) file extension and may be an object of a web page or strictly “played” in the standalone Flash Player.

ActionScript is an ECMA (Sun Microsystems standard) script-based programming language used for scripting Adobe Flash movies and applications. Since both ActionScript and JavaScript are based on the same ECMAScript syntax, fluency in one theoretically translates easily to the other. However, while JavaScript's DOM (document object model) is browser window, document and form centric, the ActionScript DOM is movie centric, which may include animations, audio, text and event handling.

To run an ActionScript software tool from a Web site, the developer inserts a .swf application into an HTML document, an XML document or the code of some type of page description language, which instruct the browser to download the appropriate .swf movie from the Web server and then execute the interactive graphic organizer.

The illustrative embodiment of the present invention is described relative to a software tool in the ActionScript programming language. However, the present invention is not limited to the specific embodiment. It should be noted that other languages can have different forms of a program that perform the same function, and the present invention can be used in a programming environment other than ActionScript. Furthermore, the present invention is not specifically limited to an ActionScript software tool executed from a Web browser, and may be implemented as various types of code modules in accordance with the teachings of the present invention.

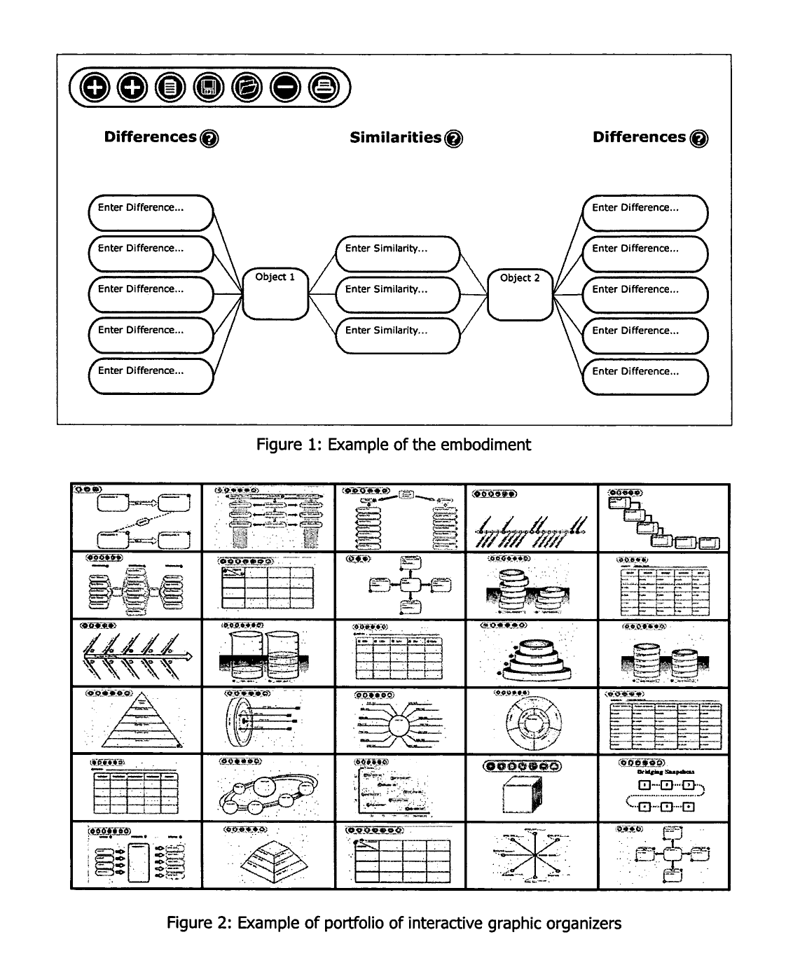

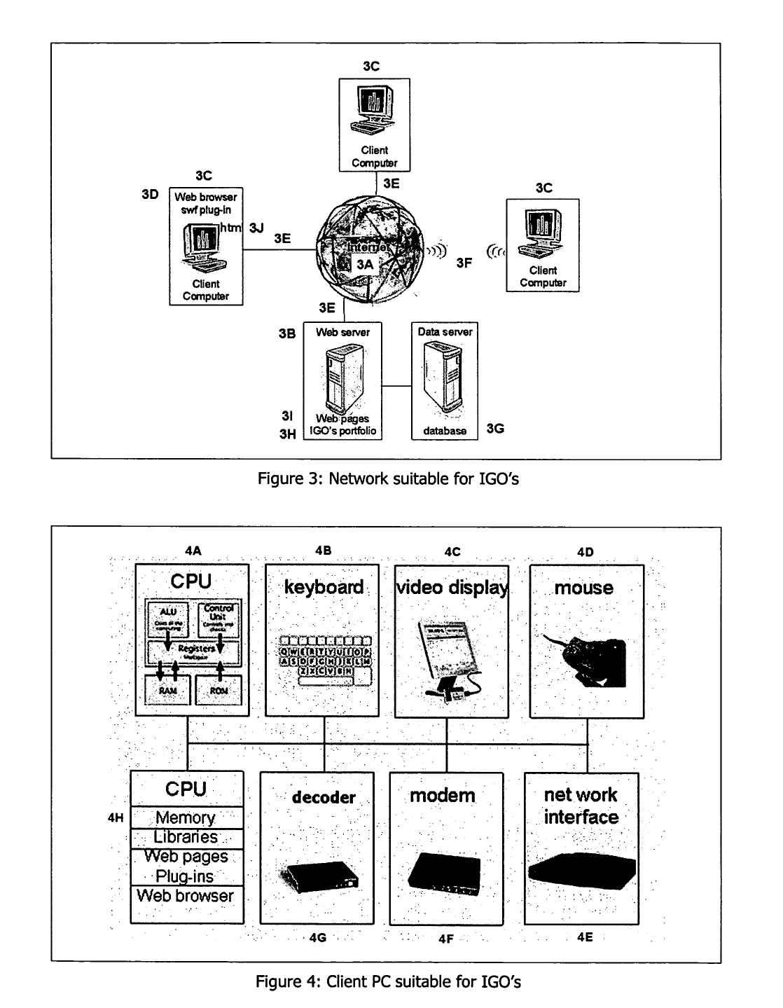

FIG. 3 illustrates a block diagram of a network 3A suitable for implementing an on-line educational course and running the interactive software tool of the illustrative embodiment of the present invention. The network 3A includes a Web server 3B and a plurality of client machines 3C connected to the web server 3B and running an ActionScript enabled Web browser 3D. The Web server 3B and the client machines 3C are connected to a network 3A via communications links 3E o 3F. The Web server 3B includes a database 3G, Small Web Files 3H, and Web pages 3I. The Web browsers 3I on the client machines 3C locate and display Web pages. A Web browser further includes an HTML interpreter 3J.

FIG. 4 is a more detailed block diagram of an exemplary client machine 3C. The client machine includes a central processing unit 4A, a keyboard 4B enabling a user to enter data into the client machine 3C, a video display screen 4C and a mouse 4D or other pointing device for controlling the movement of a cursor or pointer on the display screen 4C. The client machine 3C further optionally comprises a network interface 4E for connecting the client machine to the Internet, a modem 3F for formatting data to be transmitted over telephone lines, coaxial cable, or other communication lines, a decoder 4G for translating encoded data to its original format and client memory 4H. The memory 4H contains Web pages 3I including embedded software tools 3H, AND a Web browser 3D.

The client machine 3C can be a personal computer, a workstation, an Internet appliance, a personal digital assistant, a cell phone, a set-top box with attached television, an intelligent pager or a wide variety of other items capable of communicating with a user.

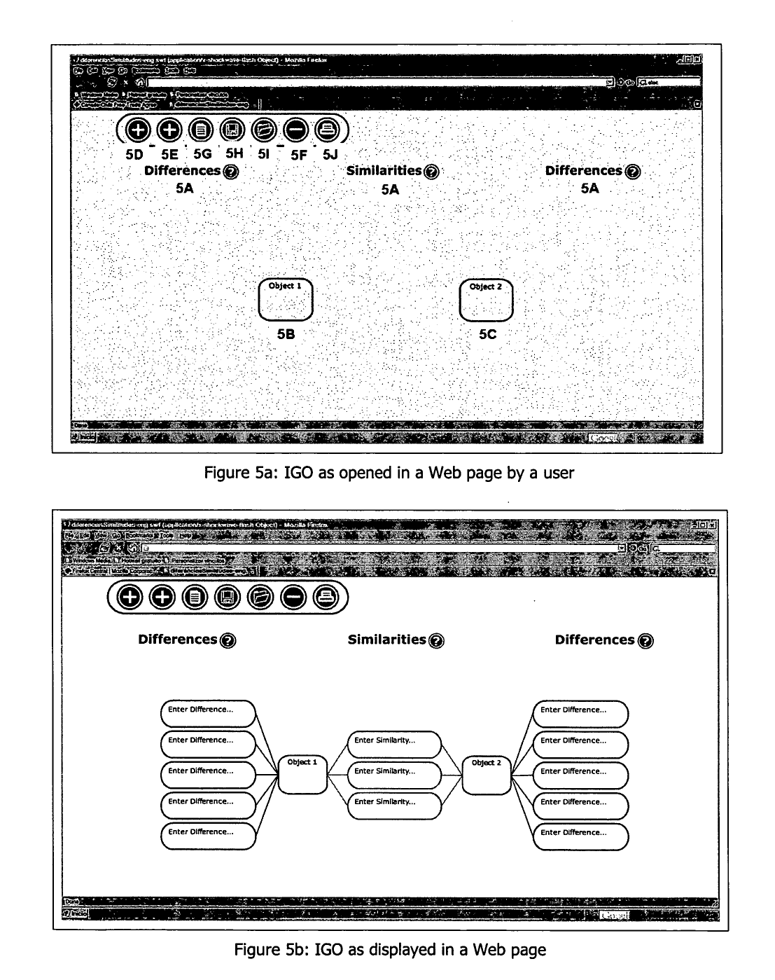

To run the interactive software tool of the illustrative embodiment of the present invention, the Web server 3E sends an HTML document with an embedded interactive software tool to a client machine 3C of the network 3A. The HTML interpreter then interprets the HTML document. The plug-in in the Web browser executes the interactive software tool and displays an Interactive Graphical Organizer Interface (IGO) on the video display screen 4C of the client 3C. The IGO, which will be described in detail with reference to FIGS. 5 through 8, displays graphic forms to be filled in by the user who can select different ways to do it.

FIG. 5a illustrates an interactive graphic organizer user interface (IGO) according to an illustrative embodiment of the present invention. The illustrated interactive software tool provides users with opportunity to practice learning strategies and skills regarding information presented in an on-line tutorial. In FIG. 5a, a browser illustrates the interactive software tool. The IGO of the illustration displays a difference and similarities diagram. The IGO further includes the two shapes to enter the objects to be compared 5B y 5C. Although the boxes 5B y 5C are shown as approximately squares having lined borders and curved corners, many variations of organization of shapes are within the scope of the invention, including no borders and other formats (rectangles, circles, cones, vases, and any other geometrical shapes). The user selects one or more differences 5D and one or more similarities 5E. By clicking on “Activate delete mode” button 5F similarities or differences can be deleted. The IGO includes other function buttons to facilitate interaction with the user. When a user clicks on a function button, the software tool responds according to particular instructions stored in the interactive software tool file: 5D—add difference; 5E—add similarity; 5F—activate/deactivate delete mode; 5G—new diagram; 5H—save diagram; 5I—open diagram; 5J—print diagram.

The IGO illustrated in FIG. 5b provides an extension of FIG. 5a, once the add similarity button 5E has been pressed three times and the add difference button 5D has been pressed five times.

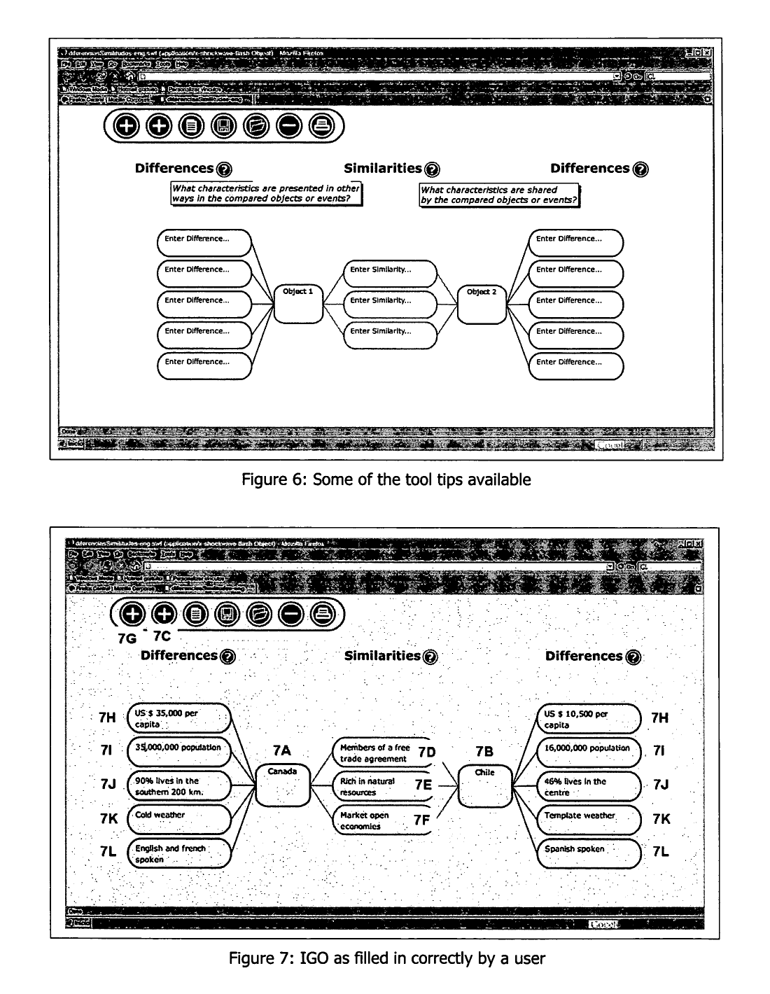

FIG. 6 illustrates some of the tool tips available for the user within the interactive graphic organizer. By locating the cursor on the question mark a message appears to assist the users with their interaction with the software tool. For example by pressing the question mark next to differences 6A it is displayed the following text: “What characteristics are presented in different ways in the compared objects”. By pressing the question mark next to similarities 6B, it is displayed the text: “What characteristics are presented in the same way in the compared objects”.

FIG. 7 illustrates how the user completes the interactive graphic organizer by inserting text in the previously added shapes (see FIG. 4b). As the shown example is with the differences and similarities interactive graphic organizer, the following explain the filling in. First the user placed the cursor in the node “Object 1” 7A and entered the text “Canada”; then the user placed the cursor in node “Object 2” 7B and entered the text “Chile”; thirdly, the user pressed, three times, the button “Add similarity” 7C and three “enter similarity . . . ” boxes opened, the user entered, in the first box, “Members of a free trade agreement” 7D; in the second, “Rich in natural resources” 7E, and “Market open economies” 7F in the third. Similarly, the user pressed five times the button “Add difference” 7G and entered the following five pairs of differences 7H: “US$35,000 per capita” for the Canada column and “US$10,500” for the Chile column; 7I: “35,000,000 population” for Canada and “17,000,000 for Chile; 7J “90% lives in the southern 200 km.” for Canada and “40% lives in the centre” for Chile; 7K: “Cold weather” for Canada and “Template weather” for Chile; 7L: “English and French spoken” for Canada and “Spanish spoken” for Chile.

According to the materials previously seen by the user and according to the illustrative embodiment, there may be more than one correct filling in of the interactive graphic organizer.

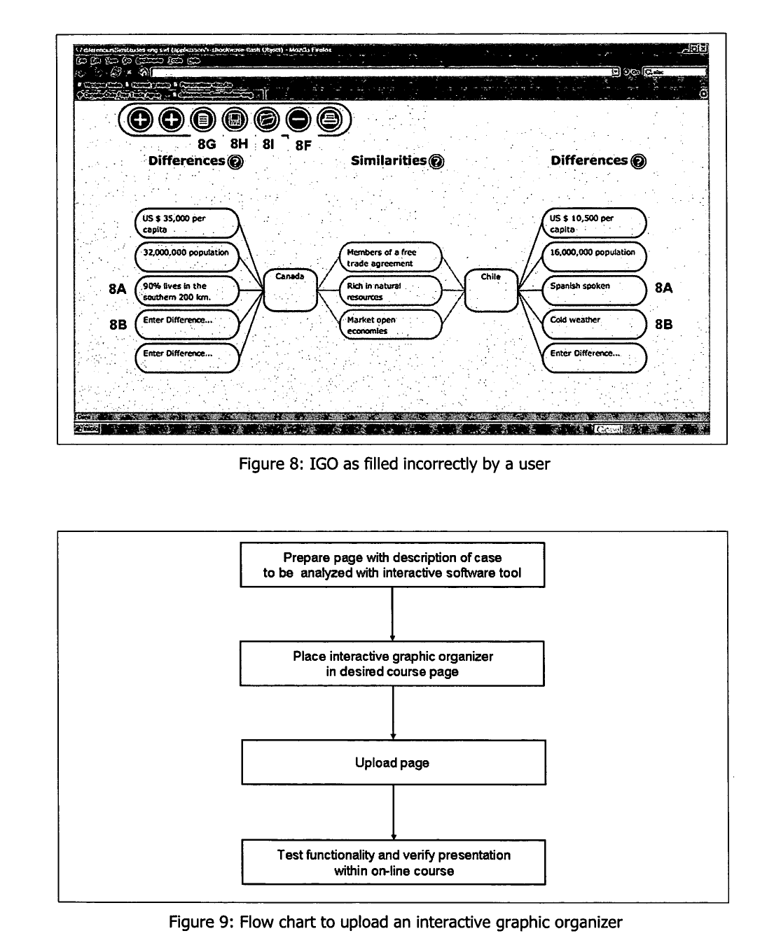

FIG. 8, a variation on FIG. 7, illustrates a possible ill filling of the interactive software tool. For the purpose of the description, similarities are as in FIG. 7: 7D, 7E and 7F, so are the first two pairs of differences 7H and 7I. However, the user may enter an incorrect pair of differences 8A: “90% lives in the southern 200 km” for Canada and “Spanish spoken” for Chile”; and 8B: blank (“Enter difference” . . . ) for Canada and “Moderate weather” for Chile. To avoid this type of ill filling, this particular interactive graphic organizer has the differences built in pairs so that the comparing skill can be practice according to the same criterion.

According to one embodiment, 8F in FIG. 8, the interactive software tool provides facilities for the user to delete shapes or rewrite in them with the purpose of correctly complete the ill filled graphic.

According to other embodiments, 8G, 8H and 8I in FIG. 8, the interactive software tool permits to create a new diagram, save a diagram and open a previously saved diagram.

According to the illustrative embodiment of the present invention, the interactive software tool is embedded in a page within the computer based course (web or local). The page is an HTML, XML, or other page description language document including a link to the interactive software tool. An HTML file is a hypertext markup language file conventionally used in creating documents on the World Wide Web or Internet. HTML defines the layout and structure of the file, using various tags and attributes. As discussed, the HTML file used in conjunction with the interactive software tool of the present invention can include graphic organizers and reference the containing small web file.

An example of an HTML fragment suitable for implementation in the illustrative case includes the following code:

```
<html xmlns=“http://www.w3.org/1999/xhtml”>
  <head>
    <meta http-equiv=“Content-Type” content=“text/html; charset=iso-8859-1” />
    <title>SAMPLE INTERACTIVE GRAPHIC ORGANIZER</title>
  </head>
  <body>
    <font size=“4” face=“Verdana, Arial, Helvetica, sans-serif”>SAMPLE
    INTERACTIVE GRAPHIC ORGANIZER<br />
    <br /> &quot;DIFFERENCES &amp; SIMILARITIES&quot;<br />
    <br /></font> <font size=“2” face=“Verdana, Arial, Helvetica, sans-serif”>Use
    this application to show differences and similarities between two objects or
    concepts. </font>
    <object classid=“clsid:D27CDB6E-AE6D-11cf-96B8-444553540000”
      codebase=“http://download macromedia.com/pub/shockwave/cabs/flash/s
      w flash.cab#version=7,0,19,0” width=“640” height=“370”>
      <param name=“movie” value=“DIF_SIM-eng.swf” />
      <param name=“quality” value=“high” />
      <embed src=“DIF_SIM-eng.swf” quality=“high”
        pluginspage=http://www.macromedia.com/go/getflashplayer
        type=“application/x-shockwave-flash” width =“640” height=“370”>
      </embed>
    </object>
  </body>
</html>
```

This code defines a small web file application embedded in an HTML document. Through the OBJECT tag and the EMBED tag, the swf application is inserted into the HTML document. The required attributes needed to insert the swf application are:
CLASSID: Identifies the ActiveX control for the browser. OBJECT only.
CODEBASE: Identifies the location of the Flash Player ActiveX control so that the browser can automatically download it if it is not already installed. OBJECT only.
WIDTH: Specifies the width of the movie in either pixels or percentage of browser window.
HEIGHT: Specifies the height of the movie in either pixels or percentage of browser window.
SRC: Specifies the location (URL) of the movie (swf application) to be loaded. EMBED only.
PLUGINSPAGE: Identifies the location of the Flash Player plug-in so that the user can download it if it is not already installed. EMBED only.
MOVIE: Specifies the location (URL) of the movie (swf application) to be loaded. OBJECT only.

The ActionScript definition file written for the interactive software tool (interactive graphic organizer) of the present invention includes the functions and other parameters which are hidden from the user. For example the inclusions or deletions of shapes retain display symmetry whether the number of shapes is par or odd. A definition file for the interactive software tool of the illustrative embodiment of the present invention may include the following code, which is illustrative of one embodiment of the invention and is not to be construed in a limiting sense:

```
function deleteSimilarity(xVar:Number):Void {
    if (numberSimilarity>0) {
        listSimilarity = newLinkedList();
        for (yVar=1; yVar<=numberSimilarity; yVar++) {
            listSimilarity.insert(this[“similarity”+yVar].text_txt.text);
        }
        removeMovieClip(this[“similarity”+numberSimilarity]);
        removeMovieClip(this[“lineSimilarity”+numberSimilarity]);
        numberSimilarity−−;
        listSimilarity.deleteEl(xVar);
        this.createEmptyMovieClip(“lineSimilarity”+numberSimilarity,
        this.getNextHighestDepth());
        for (yVar=1; yVar<=numberSimilarity; yVar++) {
            yRepos = 95–20*(numberSimilarity−1);
            yPos = 40*yVar;
            this[“similarity”+yVar]._y = yPos+yRepos;
            this[“similarity”+yVar]._x = A._x+80;
            this[“similarity”+yVar]._deleteme = false;
            this[“similarity”+yVar].text_txt.text= listSimilarity.show(yVar).content;
            this[“lineSimilarity”+yVar].clear();
            this[“lineSimilarity”+yVar].lineStyle(1, 0x00CC00, 100);
            this[“lineSimilarity”+yVar].moveTo(B._x−10, B._y+18);
            this[“lineSimilarity”+yVar].lineTo(this[“similarity”+yVar]._x+119,
            this[“similarity”+yVar]._y+15);
            this[“lineSimilarity”+yVar].moveTo(A._x+52, A._y+18);
            this[“lineSimilarity”+yVar].lineTo(this[“similarity”+yVar]._x−2,
            this[“similarity”+yVar]._y+15);
        }
    }
}
```

In the example set forth above, the scrip checks the number of inserted shapes and if this number is greater then zero the shape is deleted. Then a list named ListSimilarity is generated, where input text is kept. Next the similarity movie is deleted and so are all associated connectors and the similarity counter is lessened. Finally, the other similarities are repositioned and their texts are moved to their new positions. All this provides the effect that an intermediate shaped was deleted rather than the last one.

To run an ActionScript software tool from a Web site, the developer inserts a .swf application into an HTML document, an XML document or the code of some type of page description language, which instruct the browser to download the appropriate .swf movie from the Web server and then execute the interactive graphic organizer.

FIG. 9 illustrates the steps involved for computer based educational course (web or local) developer to incorporate an interactive software tool of the illustrative embodiment of the present invention. At some point in the educational course, the developer may include an interactive software tool of the present invention for the practice of the user's learning strategies and skills. First, in step 9A, the developer prepares a web page with contents related to the strategy or skill to be practice. Next, in step 9B, the developer makes the link to the desired interactive graphic organizer. Then the developer should upload into a leaning management system and test and verify its proper utility.

Otherwise an interactive graphic organizer can be used in a standalone personal computer configuration.

These examples are meant to be illustrative and not limiting. The present invention has been described by way of example (more examples are shown in FIG. 3), and modifications and variations of the exemplary embodiments will suggest themselves to skilled artisans in this field without departing from the spirit of the invention. For example, the present invention is not limited to an ActionScript software tool executed from a Web browser, and can include any program executed from another application. The described software tool is not limited to execution from a pop-up Web page and can be embedded in any suitable document code in any suitable programming language.

Features and characteristics of the above-described embodiments may be used in combination. This description is to be construed as illustrative only and is for the purpose of teaching those skilled in the art the best mode for carrying out the invention. The preferred embodiments are merely illustrative and should not be considered restrictive in any way. Details of the structure may vary substantially without departing from the spirit of the invention, and exclusive use of all modifications that come within the scope of the appended claims is reserved. It is intended that the invention be limited only to the extent required by the appended claims and the applicable rules of law. The scope of the invention is to be measured by the appended claims, rather than the preceding description, and all variations and equivalents that fall within the range of the claims are intended to be embraced therein.

What is claimed is:

1. In an electronic device that provides a computer based learning environment (web or local host), a method comprising: providing an interactive software tool, wherein the software tool generates a graphical user interface displaying shapes and connectors to practice learning strategies and skills by filling in the various nodes. Shapes and connectors are associated to particular functions that allow the interactive software tool to work as a stand alone software or be easily integrated to larger educational software.

2. The method of claim 1, wherein the interactive software tool provides tool tips to the user indicating the expected and correct use.

3. The method of claim 1, wherein the interactive software tool permits a predetermined number of nodes for the user to enter a correct completion.

4. The method of claim 3, wherein the interactive software tool automatically provides a maximum of shapes and connectors so as to have a graphic representation reasonably distributed on the video display.

5. The method of claim 4, wherein the interactive software tool prevents the user from entering more shapes or connectors than reasonable for the displaying purposes.

6. The method of claim 1, wherein the interactive software tool is a “Small Web File”.

7. In an electronic device that provides a computer based educational course, a method comprising: receiving a request for a Web page at the electronic device from a remote client; and in response to the receiving step, sending a Web page containing an interactive software tool embedded therein to the remote client, wherein the interactive software tool generates an interactive graphical organizer (IGO) including instructions to a user to fill in the shapes provided by the Web page.

8. The method of claim 7, wherein the Web page may comprise a page of an on-line educational course.

9. The method of claim 7, wherein the Web page including the interactive software tool instructing a user to execute correctly the filling of the graphic forms.

10. The method of claim 7, wherein the interactive software tool includes a symmetric display of shapes independently if the number of shapes is even or uneven.

11. The method of claim 10, wherein the definition file is separate from a source code for the Web page to prevent a user from viewing the source code.

12. The method of claim 9, wherein the instructions are part of the small web file.

13. A computer-readable medium for use in an electronic device that provides a computer based educational course, comprising instructions for running an interactive software tool for displaying a graphical organizer through shapes and connectors, wherein the users can enter text as a practice of their learning strategies and skills.

14. The computer-readable medium of claim 13, wherein the instructions are executable on a virtual machine.

15. The computer-readable medium of claim 13, wherein the instructions are stored on a server and downloaded to a local processor of the user.

16. The computer-readable medium of claim 13, wherein the medium includes hypertext markup language (HTML) code to reference the interactive software tool.

17. The computer-readable medium of claim 16, wherein the HTML code includes the reference to the small web file.

18. The computer-readable medium of claim 13, wherein the interactive software tool is a small web file.

19. An electronic device for providing a computer based (web or local) educational course comprising a processor; a display screen; and memory including a Web page having an interactive software tool embedded therein, wherein the processor executes the interactive software tool to generate a graphical user interface on the display screen, the graphical user interface displaying a specific graphic organizer.

20. The electronic device of claim 19, further comprising a browser for locating and displaying the Web page.

21. The electronic device of claim 20, further comprising a network connection for connecting the electronic device to a computer network.

22. The electronic device of claim 21, further comprising input media to allow the user to enter the answer.

23. The computer-readable medium of claim 19, wherein the interactive software tool is a small web file.
